(19) United States
(12) Patent Application Publication
(10) Pub. No.: US 2016/0042131 A1
(43) Pub. Date: Feb. 11, 2016

(54) VISITOR INFORMATION SYSTEM, MANAGEMENT SERVER, AND VISITOR INFORMATION MANAGEMENT METHOD

(71) Applicants: Hideki SAITOH, Tokyo (JP); Takaaki KOBAYASHI, Kanagawa (JP); Shizue SUNAGA, Tokyo (JP)

(72) Inventors: Hideki SAITOH, Tokyo (JP); Takaaki KOBAYASHI, Kanagawa (JP); Shizue SUNAGA, Tokyo (JP)

(73) Assignee: RICOH COMPANY, LTD., Tokyo (JP)

(21) Appl. No.: 14/818,393

(22) Filed: Aug. 5, 2015

(30) Foreign Application Priority Data
Aug. 7, 2014 (JP) 2014-161865

(51) Int. Cl. G06F 19/00; H04W 12/06; H04W 4/04

(52) U.S. Cl. CPC G06F 19/327; H04W 4/04; H04W 12/06

(57) ABSTRACT

A disclosed visitor information system includes a processor programmed to execute a process including registering, as group information for groups of visitors, group identification information of a group, and medium identification information of authentication media owned by respective visitors, and registering, upon authentication being normally performed by the login operation using the authentication medium, identification information or locational information of an apparatus via which a first visitor has performed a login operation in visitor information corresponding to the group information based on the medium identification information; and acquiring, upon authentication being normally performed by the login operation using the authentication medium, locational information of a second visitor belonging to the same group as the first visitor from the group information, based on the medium identification information and the group identification information to provide the first visitor with information including the acquired locational information of the second visitor.

### BACKGROUND OF THE INVENTION

1. Field of the Invention

The disclosures discussed herein relate to a technology to provide visitors of an institution with information.

2. Description of the Related Art

In general, there is a large number of patients in outpatient departments of large hospitals such as general hospitals. Hence, most of patients and attendants to the patients may need to wait a long time, thereby failing to efficiently use their time. Such scenarios may be observed not only in the large hospitals but also in institutions having a large number of visitors.

### RELATED ART DOCUMENT

### Patent Document

Patent Document 1: Japanese Laid-open Patent Publication No. 2001-202494

### SUMMARY OF THE INVENTION

Accordingly, it is a general object in one embodiment of the present invention to provide a technology to allow a group of visitors to mutually check locations and the like of visitor members of the group such that the visitors are able to efficiently use their time in the visited institution that substantially obviate one or more problems caused by the limitations and disadvantages of the related art.

According to an aspect of embodiments, there is provided a visitor information system that includes a processor programmed to execute a process including registering, as group information for groups of visitors, group identification information of a group, and medium identification information of authentication media owned by respective visitors, and registering, upon authentication being normally carried out by the login operation using the authentication medium, identification information or locational information of an apparatus via which a first visitor has performed a login operation in visitor information corresponding to the group information based on the medium identification information of the authentication medium; and acquiring, upon authentication being normally carried out by the login operation using the authentication medium, locational information of a second visitor belonging to the same group as the first visitor from the group information, based on the medium identification information of the authentication medium and the group identification information of the group to provide the first visitor with information including the acquired locational information of the second visitor.

Other objects, features and advantages of the present invention will become more apparent from the following detailed description when read in conjunction with the accompanying drawings.

### BRIEF DESCRIPTION OF THE DRAWINGS

FIG. 1 is a diagram illustrating a configuration example of a system according to a first embodiment;

FIG. 2 is a diagram illustrating a hardware configuration example of a multifunction peripheral;

FIG. 3 is a diagram illustrating a hardware configuration example of an information processing apparatus and a management server;

FIG. 4 is a diagram illustrating functional configuration examples of a multifunctional peripheral, an information processing apparatus, and a management server;

FIG. 5 is a diagram illustrating a data structure example of a group information database;

FIG. 6 is a diagram illustrating a data structure example of a medical examination recipient information database;

FIG. 7 is a diagram illustrating a data structure example of a receiving medical examination schedule table;

FIG. 8 is a diagram illustrating a data structure example of a map information database;

FIG. 9 is a sequence diagram illustrating a registration process example of the group information and the medical examination recipient information;

FIG. 10 is a sequence diagram illustrating a process example at an MFP login;

FIG. 11 is a flowchart illustrating a process example of generating providing information;

FIG. 12 is a first diagram illustrating an example of providing information; and

FIG. 13 is a second diagram illustrating an example of providing information.

### DETAILED DESCRIPTION OF THE PREFERRED EMBODIMENTS

In the following, a description is given of embodiments with reference to accompanying drawings. Note that in the following description, a hospital is given as an example of an institution to which the present invention is applied; however, the present invention may be applicable to any other institutions other than the hospital.

### Configuration

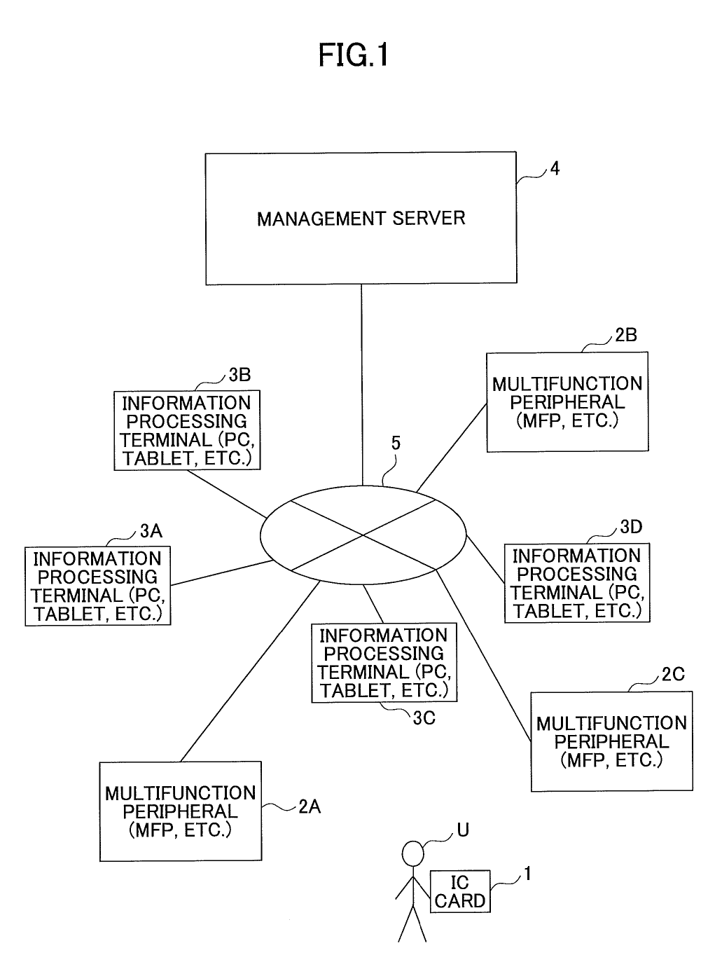

FIG. 1 is a diagram illustrating a configuration example of a system according to an embodiment, which specifically illustrates a system configuration within a hospital (an institution). In FIG. 1, a user U who is a visitor to a hospital has an IC card 1 as an authentication medium that is distributed by the hospital. Visitors to the hospital include medical examination recipients who receive physical examinations and inspections, and attendants who attend to the medical examination recipients. The medical examination recipients include patients who receive physical examinations and inspections for medical treatments, and medical check-up recipients who receive physical examinations and inspections for health care. In the hospital, information processing terminals 3A, 3B, 3C, 3D, . . . such as PCs (personal computers) and tablets, multi-function peripherals MFPs 2A, 2B, 2C, . . . (e.g., multi-function peripherals, multi-function printers), and a management server 4 are disposed, which are mutually in communication via a network 5 such as a LAN (local area network). Note that the network 5 utilized in the embodiment may be wired or wireless.

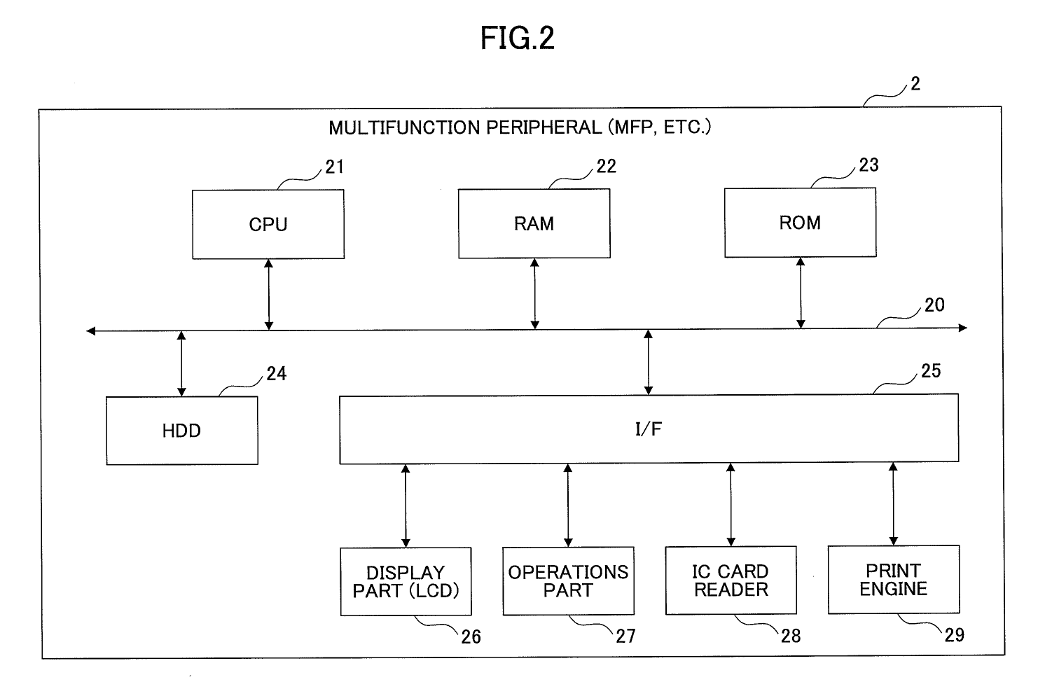

FIG. 2 is a diagram illustrating a hardware configuration example of a MFP 2 (2A to 2C, etc.). In

FIG. 2, the MFP 2 includes a CPU (central processing unit) 21, a RAM (random access memory) 22, a ROM (read only memory) 23, an HDD (hard disk drive) 24, an I/F (interface) 25, a display part 26 connected to the I/F 25, an IC card reader 28, and a print engine 29 that are connected via a bus 20.

The CPU 21 is configured to integrally control operations of a main body of the MFP 2 by executing a program stored in the ROM 23 or the HDD 24, using the RAM 22 as a work area. A display part 26 is formed of an LCD (liquid crystal display) and the like, and is configured to display predetermined information with respect to a user of the MFP 2. A operations part 27 is a touch panel or a mechanical button and is configured to receive operations from the user of the MFP 2. The IC card reader 28 is configured to read information recorded in the IC card 1 (see FIG. 1) when the IC card 1 is located close to the IC card reader 28. The print engine 29 is configured to print predetermined information.

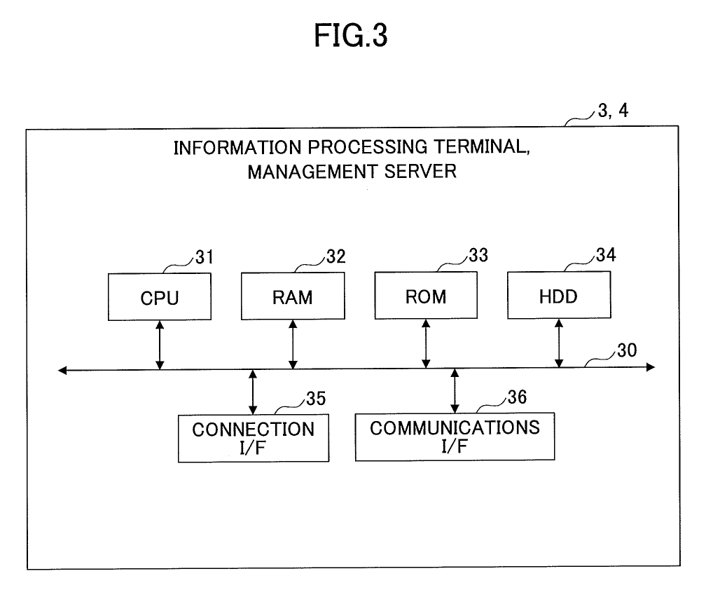

FIG. 3 is a diagram illustrating a hardware configuration example of the information processing terminal 3 (3A to 3D, etc.), and the management server 4. In FIG. 3, each of the information processing terminals 3 and the management server 4 has a CPU 31, a RAM 32, a ROM 33, an HDD 34, a connection I/F 35, and a communications I/F 36.

The CPU 31 is configured to integrally control operations of a main body of the information processing terminal 3 or the management server 4 by executing a program stored in the ROM 33 or the HDD 34, using the RAM 32 as a work area. The connection I/F 35 serves as an interface between the information processing terminal 3 or the management server 4 and an apparatus connected to the main body of the information processing terminal 3 or the management server 4. The communications I/F 36 is an interface for performing communications with other information apparatuses via the network 5 (see FIG. 1).

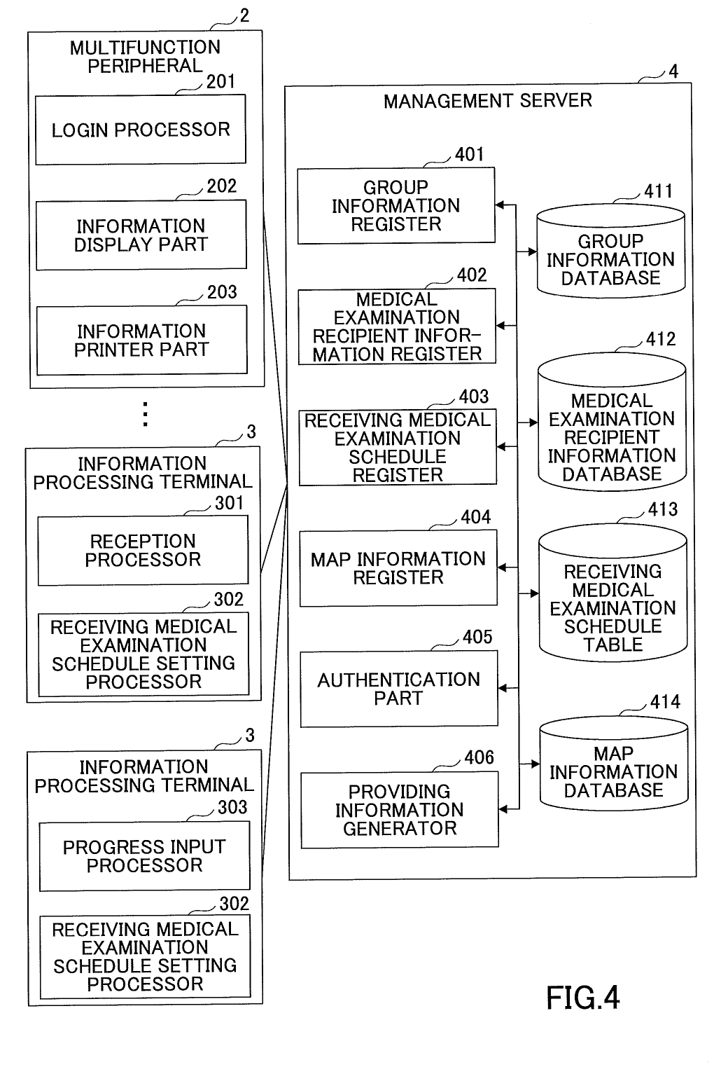

FIG. 4 is a diagram illustrating functional configurations of the MFP 2 (2A to 2C, etc.), the information processing terminal 3 (3A to 3D, etc.), and the management server 4.

In FIG. 4, the MFP 2 includes a login processor 201, an information display part 202, and an information printer part 203. The login processor 201 is configured to receive a login operation by using the IC card 1 (FIG. 1), and causing the management server 4 to authenticate the IC card 1 to log in the management server 4. The authentication may be validated by verifying the IC card number retrieved from the IC card 1 that has been registered in advance in the management server 4, or may be validated by requesting a user to input a password or PIN (personal identification number) for improving security. In this case, the passwords or PINs may be managed by the management server 4 in association with the respective IC card numbers.

The information display part 202 has a function to display predetermined information to the user of the MFP 2. In this embodiment, the information display part 202 is utilized for displaying a map image and a receiving medical examination schedule list. The information printer part 203 has a function to print the predetermined information on a sheet to provide the user of the MFP 2 with the predetermined information printed on the sheet. In this embodiment, the information printer part 203 is utilized for printing the map image and the receiving medical examination schedule list on the sheet in accordance with the user's operations.

The information processing terminal 3 used as a reception terminal includes a reception processor 301 and a receiving medical examination schedule setting processor 302. The reception processor 301 has a function to register in the management server 4 information associated with a group including attendants or accompanying members, and information about a medical information recipient for each of the visitors. The receiving medical examination schedule setting processor 302 has a function to register in the management server 4 information about a route of receiving medical examination with respect to receiving medical examination content.

The information processing terminal 3 used as a progress input terminal includes a progress input processor 303 and a receiving medical examination schedule setting processor 302. The progress input processor 303 has a function to register information such as start and end of receiving a medical examination in a medical examination receiving site. The receiving medical examination schedule setting processor 302 is already described above.

The management server 4 includes functional parts having a group information register 401, a medical examination recipient information register 402, a receiving medical examination schedule register 403, a map information register 404, an authentication part 405, and a providing information generator 406. These functional parts may be implemented by a computer program executed on hardware resources forming the management server 4 such as a CPU, a ROM, and a RAM of a computer. The functional parts are not necessarily disposed on a single computer, and may optionally be distributed on two or more computers.

Further, the management server 4 includes a group information database 411, a medical examination recipient information database 412, a receiving medical examination schedule table 413, and a map information database 414 as databases to be referred to and to be updated while processing. The above-described databases are used for systematically maintaining predetermined data in a storage area of a storage medium such as an HDD inside the management server 4. These databases are not necessarily disposed on a single computer, and may optionally be distributed on two or more computers.

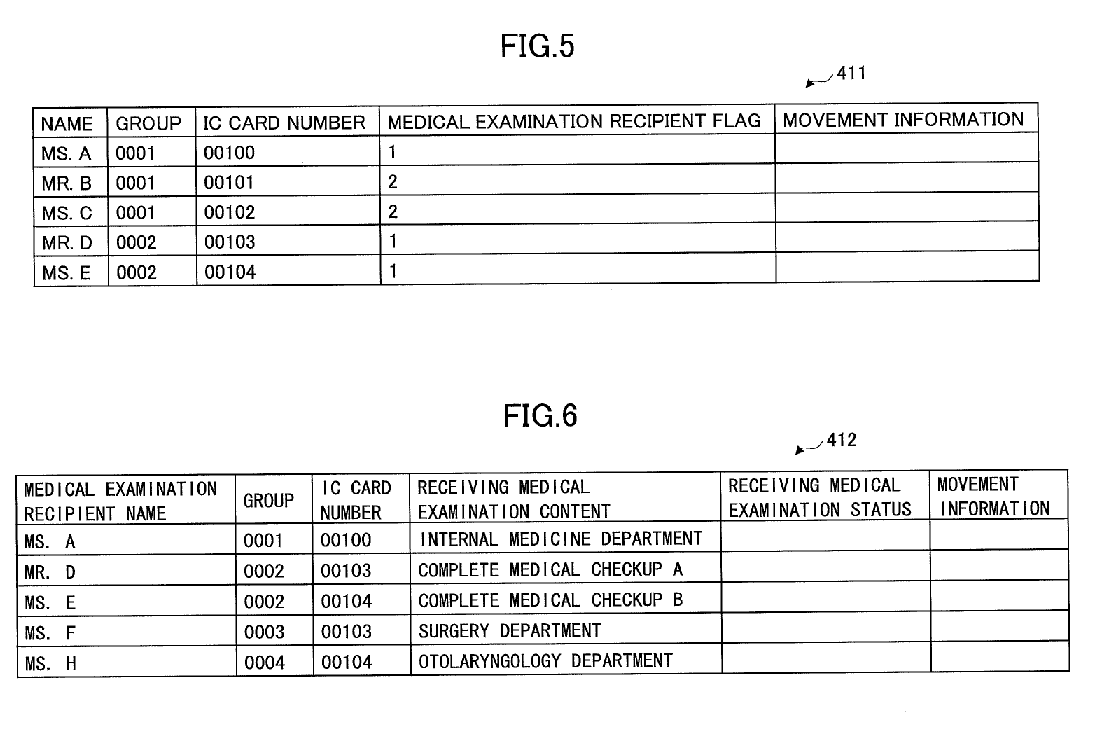

FIG. 5 is a diagram illustrating a data structure example of a group information database 411 that includes items (fields) such as a “name”, a “group”, an “IC card number”, a “medical examination recipient flag”, and “movement information”. The “name” indicates information illustrating a name of each of visitors. The “group” indicates information identifying a group to which the corresponding visitor belongs. The “IC card number” indicates information identifying each of the IC cards distributed to the visitors. The “medical examination recipient flag” illustrates information indicating whether each of the visitors is a medical examination recipient. In FIG. 5, “1” of the medical examination recipient flag indicates a medical examination recipient, and “2” of the medical examination recipient flag indicates a non-medical examination recipient (e.g., an attendant to the medical examination recipient). The “movement information” indicates identification information (MFP-ID) of the MFP 2 via which a visitor has performed a login operation or locational information of the MFP 2 inside the hospital recorded together with date and time when the visitor is normally authenticated by operating the login operation on any of the MFPs 2 using the IC card 1. Further, the “movement information” may include records of accesses to predetermined areas (e.g., entering into or leaving from the predetermined areas).

FIG. 6 is a diagram illustrating a data structure example of a medical examination recipient information database 412 that includes items (fields) such as a “medical examination recipient name”, a “group”, an “IC card number”, a “receiving medical examination content”, a “receiving medical examination status” and “movement information”. The “medical examination recipient name” indicates information illustrating a name of each medical examination recipient. The “group” indicates information identifying a group to which the corresponding medical examination recipient belongs. The “IC card number” indicates information identifying each of the IC cards distributed to the medical examination recipients. The “receiving medical examination content” indicates information illustrating a department of the medical examination or a type of a complete medical check-up received by each medical examination recipient. The “receiving medical examination status” indicates a completed status or an incomplete status of the medical examination, and completed date and time of the medical examination. The “movement information” indicates identification information (MFP-ID) of the MFP 2 via which the medical examination recipient has performed the login operation or locational information of the MFP 2 inside the hospital recorded together with date and time when the medical examination recipient is normally authenticated by performing the login operation on any of the MFPs 2 using the IC card 1. Further, the “movement information” may include records of accesses to predetermined areas (entering into or leaving from the predetermined areas).

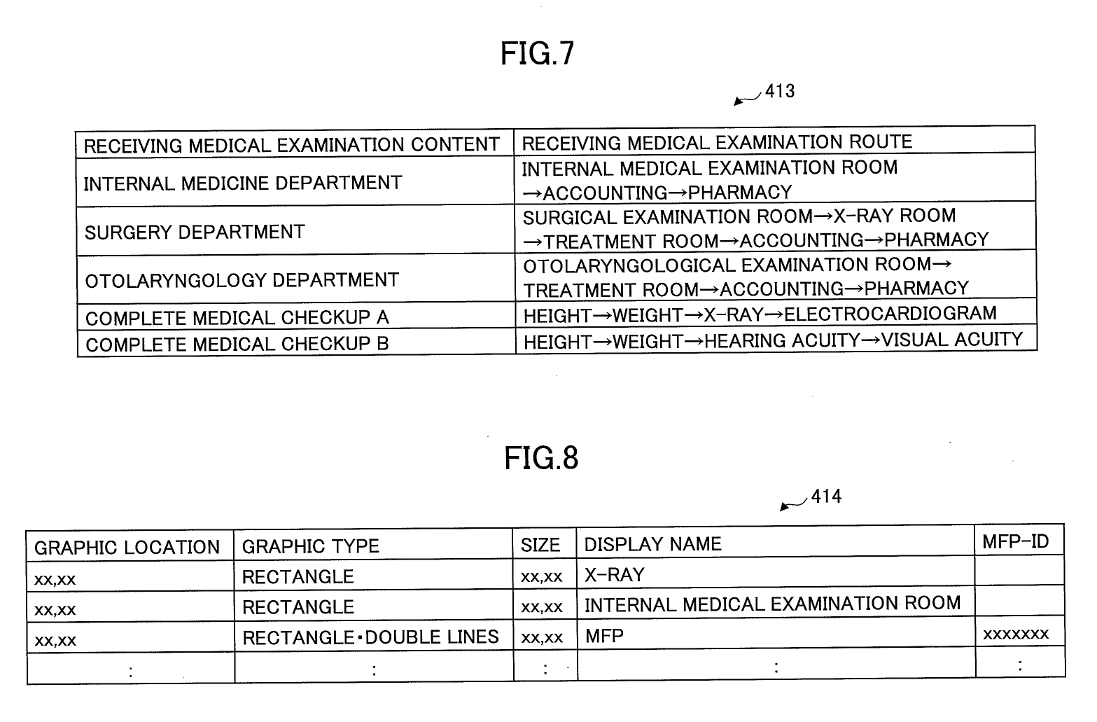

FIG. 7 is a diagram illustrating a data structure example of the receiving medical examination schedule table 413 that includes items such as “receiving medical examination content”, and “receiving a medical examination route”. The “receiving medical examination content” is information indicating a department of the medical examination or a type of the complete medical check-up received by the medical examination recipient. The “receiving medical examination content” corresponds to the “receiving medical examination content” of the medical examination recipient information database 412. The receiving a medical examination route illustrates locations moved or traveled to in accordance with the receiving medical examination contents inside the hospital in a chronological order.

FIG. 8 is a diagram illustrating a data structure example of the receiving medical examination schedule table 414 that includes items such as a “graphic location”, a “graphic type”, a “size”, a “display name”, and an “MFP-ID”. The “graphic location” indicates a location of a graphic illustrating a subject on a map in a map area of the hospital. The “graphic type” indicates a type (rectangular, circle, line, etc.) of the graphic. The “size” indicates information illustrating a size of the graphic. The “display name” indicates information illustrating a name assigned to the graphic. The “MFP-ID” indicates identification information of the actually disposed MFP 2 when the graphic corresponds to the MFP. Note that locational information of the actually disposed MFP 2 inside the hospital may be recorded instead of the “MFP-ID”.

Referring back to FIG. 4, the group information register 401 of the management server 4 has a function to register or update the group information in the group information database 411, upon receiving a request of registering the visitors constituting the group from the reception processor 301 of the information processing terminal 3, or a request of registering the locational information at login from the providing information generator 406.

The medical examination recipient information register 402 has a function to register or update medical examination recipient information in the medical examination recipient information database 412, upon receiving a request of registering the medical examination recipient information from the reception processor 301 of the information processing terminal 3, or a request of registering the receiving medical examination status or the movement information from the progress input processor 303 of the information processing terminal 3.

The receiving medical examination schedule register 403 has a function to register or update receiving medical examination schedule information in the receiving medical examination schedule table 413, upon receiving a request of registering the receiving medical examination schedule from the receiving medical examination schedule setting processor 302 of the information processing terminal 3.

The map information register 404 has a function to register or update map information inside the hospital in the map information database 414 in accordance with an operation of an administrator.

The authentication part 405 has a function to perform authentication based on registration information of the group information database 411 or the medical examination recipient information database 412, upon receiving an authentication request from the login processor 201 of the MFP 2.

The providing information generator 406 has a function to acquire the latest locational information of other visitors belonging to the same group as the visitor who has performed the login operation, based on the IC card number and the group from the group information of the group information database 411 or the medical examination recipient information of the medical examination recipient information database 412 when the authentication is normally performed by the authentication part 405, or also has a function to acquire the receiving medical examination schedule and provide the visitor who has performed a login operation with information when the visitor is the medical examination recipient.

### Operations

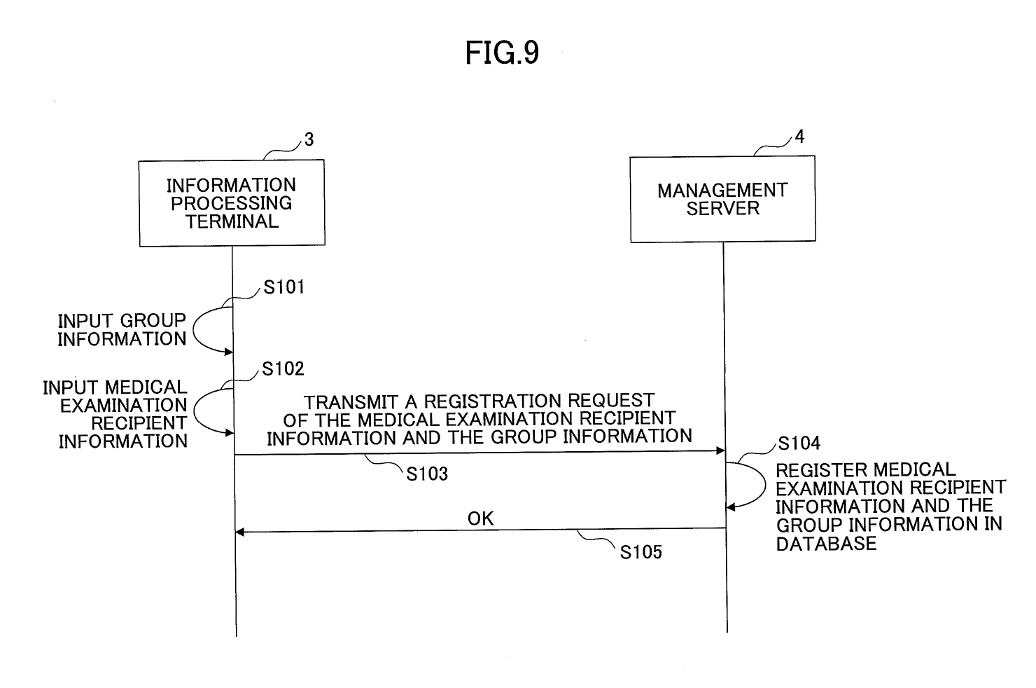

FIG. 9 is a sequence diagram illustrating a registration process example of the group information and the medical examination recipient information in the above-described embodiment.

As illustrated in FIG. 9, in the reception processor 301 of the information processing terminal 3, information about the group is input (step S101), and information about the medical examination recipient is input (step S102). When the above-described inputs are completed, the input information about the group and the input information about the medical examination recipient are transmitted to the management server 4 (step S103).

The group information register 401 and the medical examination recipient information register 402 register the respective sets of information in the group information database 411 and the medical examination recipient information database 412 based on these sets of information (step S104). Then, when the respective registrations are normally performed, the group information register 401 and the medical examination recipient information register 402 transmit such indications to the information processing terminal 3 of the request source (step S105).

Note that the information about the group may not only be registered by the information processing terminal 3 but may also be registered by the visitor who directly operates the MFP 2. In this case, the visitor is requested to present the IC card 1, and when the presented IC card 1 is authenticated normally by the management server 4, the operation of registering information about the group is received.

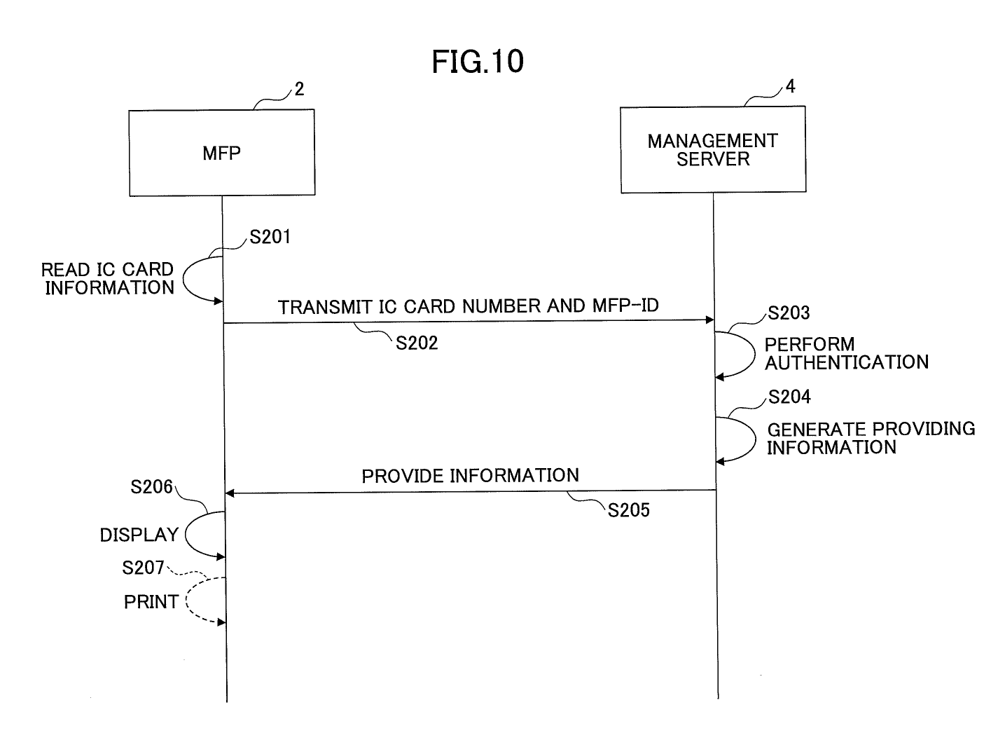

FIG. 10 is a sequence diagram illustrating a process example at an MFP login.

As illustrated in FIG. 10, when the visitor holds the IC card 1 over the MFP 2, the login processor 201 of the MFP 2 reads the IC card information including the IC card number (step S201), and transmits the IC card number and identification information (MFP-ID) of the MFP 2 to the management server 4 (step S202).

The authentication part 405 performs authentication by matching the IC card information and the registration information in the group information database 411 or the medical examination recipient information database 412 based on the IC card number (step S203).

When the authentication is normally performed, the providing information generator 406 generates information provided for the visitor who has performed the login operation on the MFP 2 (step S204), and transmits the generated providing information to the MFP 2 (step S205).

The MFP 2 that has received the generated providing information displays the providing information via the information display part 202 (step S206), and optionally performs printing the providing information in accordance with the operations of the visitor of the user (step S207).

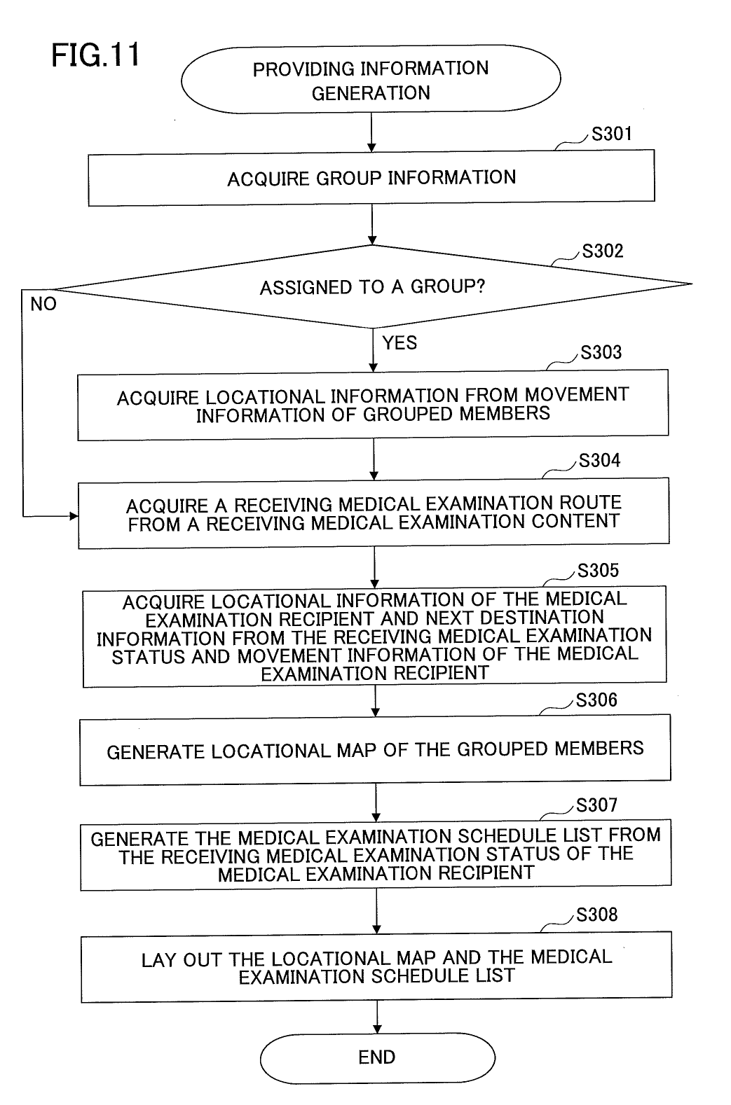

FIG. 11 is a flowchart illustrating a process example of generating providing information illustrated in step 204 of FIG. 10.

As illustrated in FIG. 11, the providing information generator 406 acquires group information from the group information database 411 using the IC card number of the login visitor as a key (step S301). Subsequently, the providing information generator 406 determines whether the login operated visitor is assigned to the “group” (any group) to see that the login visitor is grouped (a group member) (step S302).

When the login operated visitor is determined as being grouped (a group member)(“YES” in step S302), the providing information generator 406 acquires locational information (i.e., identification information or locational information of the latest login MFP 2) from the “movement information” of the member(s) who belong to the same “group” (step S303). When the login operated visitor is determined as not being grouped (not a group member)(“NO” instep S302), the providing information generator 406 skips the step S303.

Next, regardless of being grouped or not being grouped, the providing information generator 406 acquires the receiving medical examination content of the medical examination recipient from the medical examination recipient information database 412 using the IC card number as a key, and then acquires the receiving medical examination route based on the receiving medical examination content by referring to the receiving medical examination schedule table 413 (step S304).

Subsequently, the providing information generator 406 acquires location information and next destination information of the medical examination recipient based on the receiving medical examination status and the movement information of the medical examination recipient (step S305).

Next, the providing information generator 406 generates a locational map of the grouped members (step S306).

Next, the providing information generator 406 generates a receiving medical examination schedule list based on the receiving medical examination status of the medical examination recipient (step S307).

Then, the providing information generator 406 lays out the locational map and the receiving medical examination schedule list to generate providing information (step S308).

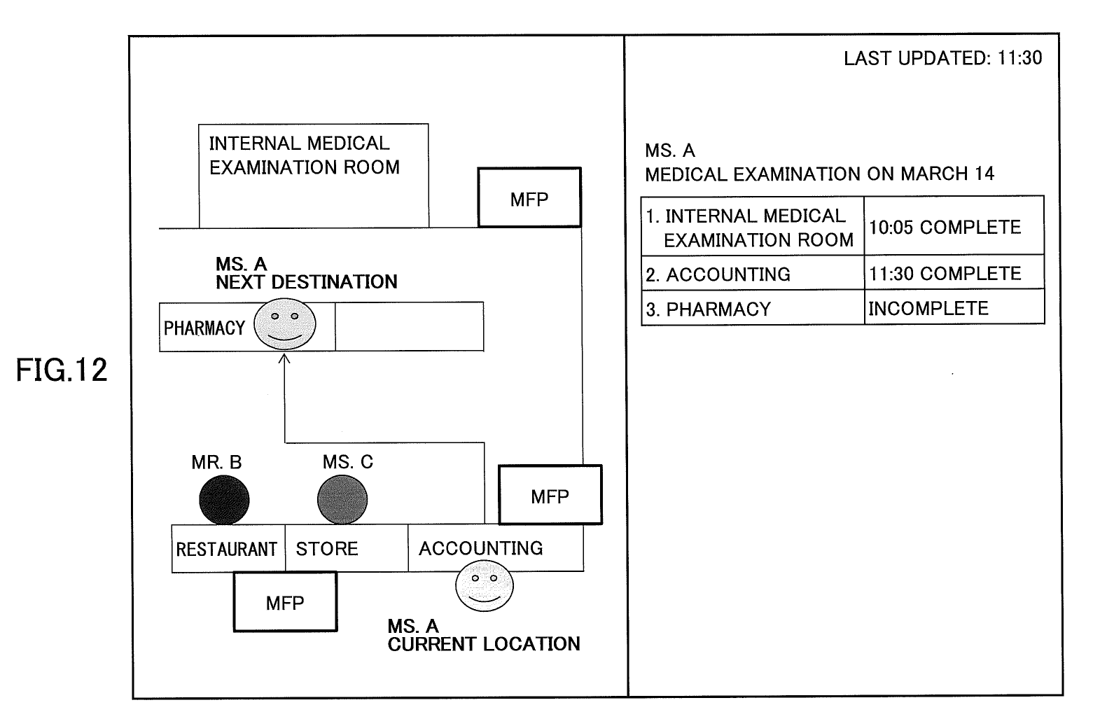

FIG. 12 is a diagram illustrating an example of the providing information, and specifically illustrates a screen example when “Ms. A” who is the medical examination recipient having logged in the MFP 2. On the left-hand side of the screen, the letters “current location of Ms. A” and a face icon, the letters “next destination of Ms. A” and a face icon, an arrowed line from the “current location of Ms. A” to the “next destination of Ms. A”, and the marks and the letters representing names of latest locations of attendants “Mr. B” and “Ms. C” belonging to the same group are displayed. On the right-hand side of the screen, the medical examination schedule list for the medical examination recipient “Ms. A” is displayed.

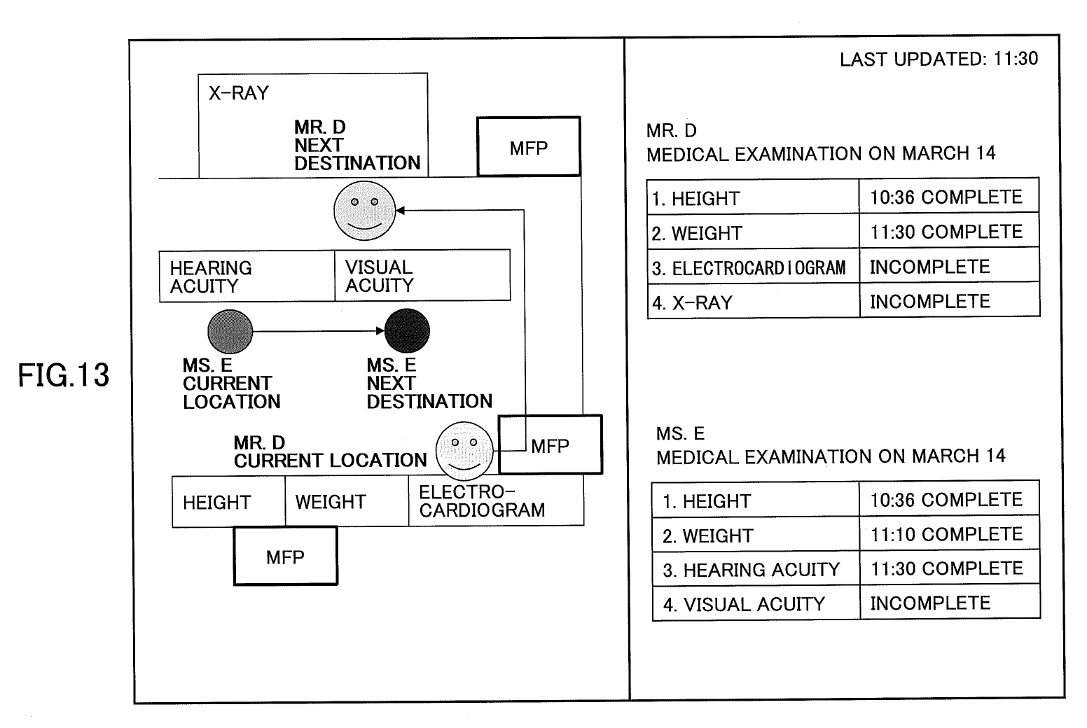

FIG. 13 is a diagram illustrating another example of the providing information, and specifically illustrates a screen example when “Mr. D” who is the medical examination recipient having logged in the MFP 2. On the left side of the screen, the letters “current location of Mr. D” and a face icon, the letters “next destination of Mr. D” and a face icon, and an arrowed line from the “current location of Mr. D” to the “next destination of Mr. D” are displayed. In addition, the letters “current location of Ms. E” and a face icon, the letters “next destination of Ms. E” and a face icon, and an arrowed line from the “current location of Ms. E” to 1E the “next destination of Ms. E” who belongs to the same group as Mr. D and is a medical examination recipient are displayed. On the right-hand side of the screen, the medical examination schedule list for the medical examination recipient “Ms. E” is displayed.

### Outline

As described above, the disclosed technology according to the embodiment enables the visitors to an institution who form a group to mutually check locations of their group members so as to efficiently use their time inside the institution.

In the disclosed technology according to the embodiment, the visitors to an institution who form a group may be able to mutually check locations of their group members so as to efficiently use their time inside the institution.

The respective parts and units of the MFP 2 (e.g., the login processor 201, the information display part 202, and the information print part 203) described in the above embodiment may be implemented by causing the CPU 21 to execute a program stored in a storage device (e.g., the ROM 23, the HDD 24, the RAM 22, or a flash memory). However, the embodiment is not limited to this configuration, and at least part of the above-described functions of the MFP 2 may be implemented by a dedicated hardware circuit (e.g., a semiconductor integrated circuit).

Further, the respective parts and units of the information processing terminal 3 (e.g., the reception processor 301, the receiving medical examination schedule setting processor 302, and the progress input processor 303) described in the above embodiment may be implemented by causing the CPU 31 to execute a program stored in a storage device (e.g., the ROM 33, the HDD 34, the RAM 32, or a flash memory). However, the embodiment is not limited to this configuration, and at least part of the above-described functions of the information processing terminal 3 may be implemented by a dedicated hardware circuit (e.g., a semiconductor intergraded circuit).

In addition, the respective parts and units of the management server 4 (e.g., the group information register 401, the medical examination recipient information register 402, the receiving medical examination schedule register 403, the map information register 404, the authentication part 405, and the providing information generator 406) described in the above embodiment may be implemented by causing the CPU 31 to execute a program stored in a storage device (e.g., the ROM 33, the HDD 34, the RAM 32, or a flash memory). However, the embodiment is not limited to this configuration, and at least part of the above-described functions of the management server 4 may be implemented by a dedicated hardware circuit (e.g., a semiconductor intergraded circuit).

Moreover, the program executed by the visitor information system (composed of the MFP 2, the information processing terminal 3, the management server 4, etc.) according to the above-described embodiment may be configured in an installable file format or in an executable file format and recorded in a computer-readable recording medium such as a CD-ROM, a flexible disk (FD), a CD-R, a DVD (digital versatile disk), a USB (universal serial bus) memory, or may be provide or distributed via a network such as the Internet. Moreover, various types of programs may be incorporated in advance in a ROM or the like.

The preferred embodiments are described above. In the above embodiments, the present invention is illustrated with specific examples; however, the present invention is not limited to these examples, and various alterations or changes may be made without departing from the gist and the scope of the claims of the present invention. Specifically, the present invention shall not be construed as being limited to details of the specific examples and accompanying drawings thereof.

The present invention is not limited to the specifically disclosed embodiments, and variations and modifications may be made without departing from the scope of the present invention.

The present application is based on and claims the benefit of priority of Japanese Priority Application No. 2014-161865 filed on Aug. 7, 2014, the entire contents of which are hereby incorporated herein by reference.

What is claimed is:

1. A visitor information system comprising:
a processor programmed to execute a process including
registering, as group information for groups of visitors, group identification information of a group, and medium identification information of authentication media owned by respective visitors, and registering, upon authentication being normally carried out by the login operation using the authentication medium, identification information or locational information of an apparatus via which a first visitor has performed a login operation in visitor information corresponding to the group information based on the medium identification information of the authentication medium; and
acquiring, upon authentication being normally carried out by the login operation using the authentication medium, locational information of a second visitor belonging to the same group as the first visitor from the group information, based on the medium identification information of the authentication medium and the group identification information of the group to provide the first visitor with information including the acquired locational information of the second visitor.

2. The visitor information system as claimed in claim 1, wherein the process further includes
registering map information inside an institution, wherein
the acquiring includes generating a map image depicting the location of the second visitor belonging to the same group as the first visitor who has performed the login operation, and providing the first visitor with information including the generated map image.

3. The visitor information system as claimed in claim 1, wherein the process further includes
registering, as medical examination recipient information, identification information of an authentication medium owned by a third visitor serving as a medical examination recipient in association with a medical examination content and a medical examination status, wherein
the acquiring includes acquiring the locational information of the third visitor serving as the medical examination recipient based on the medical examination status of the medical examination recipient information.

4. The visitor information system as claimed in claim 3, wherein
the acquiring includes providing the first visitor who has performed the login operation with information including the medical examination status of the medical examination recipient information associated with the third visitor serving as the medical examination recipient.

5. A management server comprising:
a processor programmed to execute a process including
registering, as group information for groups of visitors, group identification information of a group and medium identification information of authentication media owned by the respective visitors, and registering, upon authentication being normally carried out by performing a login operation using the authentication medium, identification information or locational information of an apparatus via which a first visitor has performed the login operation in visitor information corresponding to the group information based on the medium identification information of the authentication medium; and
acquiring, upon authentication being normally carried out by the login operation using the authentication medium, locational information of a second visitor belonging to the same group as the first visitor from the group information, based on the medium identification information of the authentication medium and the group identification information of the group to provide the first visitor with the acquired locational information of the second visitor.

6. A visitor information management method performed in a visitor information system, the visitor information management method comprising:
registering, using a processor, as group information for groups of visitors, group identification information of a group and medium identification information of authentication media owned by the respective visitors, and registering, upon authentication being normally carried out by performing a login operation using the authentication medium, identification information or locational information of an apparatus via which a first visitor has performed the login operation in visitor information corresponding to the group information based on identification information of the authentication medium; and
acquiring, using a processor, upon authentication being normally carried out by the login operation using the authentication medium, locational information of a second visitor belonging to the same group as the first visitor from the group information, based on the medium identification information of the authentication medium and the group identification information of the group to provide the first visitor with the acquired locational information of the second visitor.
